(19) United States
(12) Patent Application Publication
(10) Pub. No.: US 2022/0314925 A1
(43) Pub. Date: Oct. 6, 2022

(54) HARNESS SYSTEM WITH A BUCKLE RESTRAINING FUNCTION

(71) Applicant: Wonderland Switzerland AG, Steinhausen (CH)

(72) Inventors: Chin-Ming Cheng, Steinhausen (CH); Jui-Lu Wang, Steinhausen (CH)

(73) Assignee: Wonderland Switzerland AG, Steinhausen (CH)

(21) Appl. No.: 17/707,985

(22) Filed: Mar. 30, 2022

(30) Foreign Application Priority Data
Mar. 30, 2021 (CN) 202120642644.6

(51) Int. Cl. B60R 22/18

(52) U.S. Cl. CPC B60R 22/18

(57) ABSTRACT

A harness system with a buckle restraining function is provided and includes an upper buckle, an upper strap and a restraining device. The upper strap slidably passes through the upper buckle and includes a waist portion and a shoulder portion divided by the upper buckle. The restraining device utilizes an anti-sliding structure with high friction coefficient for engaging with the upper strap and further utilizes a stopping component for abutting against the upper buckle, which effectively restrains the upper buckle from sliding relative to the upper strap toward the waist portion for preventing a passenger's injury due to an excessive decrease of a length of the waist portion when the shoulder portion is forced during a collision or an emergency brake of a vehicle.

### BACKGROUND OF THE INVENTION

### 1. Field of the Invention

The present application relates to a harness system, and more specifically, to a harness system with a buckle restraining function.

### 2. Description of the Related Art

A harness system can secure a passenger inside a seat of a vehicle, such as a car, when the passenger sits on the seat for ensuring the passenger's safety. Please refer to FIG. 1. FIG. 1 is a partial diagram of a harness system 1′ in the related art. As shown in FIG. 1, the conventional harness system 1′ includes a buckle assembly 11′ and a strap assembly 12′. The buckle assembly 11′ includes two upper buckle components 111′ and a crotch buckle component 112′ which can be buckled with the two upper buckle components 111′. The strap assembly 12′ includes two upper strap components 121′ and a crotch strap component 122′. Each upper strap component 121′ is connected to the corresponding upper buckle component 111′ by slidably passing through the corresponding upper buckle component 111′, and each upper strap component 121′ includes a shoulder portion 1211′ and a waist portion 1212′ divided by the corresponding upper buckle component 111′. The crotch strap component 122′ is connected to the crotch buckle component 112′ by passing through the crotch buckle component 112′. The shoulder portions 1211′ and the waist portions 1212′ of the two upper strap components 121′ and the crotch strap component 122′ are connected to the seat, and the shoulder portions 1211′ and the waist portions 1212′ of the two upper strap components 121′ and the crotch strap component 122′ can cooperatively secure the passenger's body when the two upper buckle components 111′ are buckled with the crotch buckle component 112′.

### SUMMARY OF THE INVENTION

In order to solve the aforementioned problem, the present application discloses a harness system with a buckle restraining function. The harness system includes an upper buckle, an upper strap and a restraining device. The upper strap slidably passes through the upper buckle and includes a waist portion and a shoulder portion divided by the upper buckle. The restraining device is configured to restrain a sliding movement of the upper buckle relative to the upper strap and toward the waist portion when the shoulder portion is forced during a collision or an emergency brake of a vehicle.

These and other objectives of the present application will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a partial diagram of a harness system in the related art.

FIG. 2 is a partial diagram of a harness system according to an embodiment of the present application.

FIG. 3 is a partial sectional diagram of the harness system according to the embodiment of FIG. 2 of the present application.

FIG. 4 is a partial diagram of a harness system according to another embodiment of the present application.

FIG. 5 is a partial sectional diagram of the harness system according to the embodiment of FIG. 4 of the present application.

FIG. 6 is a partial diagram of a harness system according to another embodiment of the present application.

FIG. 7 is a partial sectional diagram of the harness system according to the embodiment of FIG. 6 of the present application.

FIG. 8 is a partial diagram of a harness system according to another embodiment of the present application.

FIG. 9 is a partial sectional diagram of the harness system according to the embodiment of FIG. 8 of the present application.

FIG. 10 is a partial diagram of a harness system according to another embodiment of the present application.

FIG. 11 is a partial sectional diagram of the harness system according to the embodiment of FIG. 10 of the present application.

FIG. 12 is a partial diagram of a harness system according to another embodiment of the present application.

FIG. 13 to FIG. 17 are partial diagrams of a harness system according to other embodiments of the present application.

### DETAILED DESCRIPTION

In the following detailed description of the preferred embodiments, reference is made to the accompanying drawings which form a part hereof, and in which is shown by way of illustration specific embodiments in which the invention may be practiced. In this regard, directional terminology, such as “top”, “bottom”, “left”, “right”, “front”, “back”, etc., is used with reference to the orientation of the Figure(s) being described. The components of the present application can be positioned in a number of different orientations. As such, the directional terminology is used for purposes of illustration and is in no way limiting. Accordingly, the drawings and descriptions will be regarded as illustrative in nature and not as restrictive.

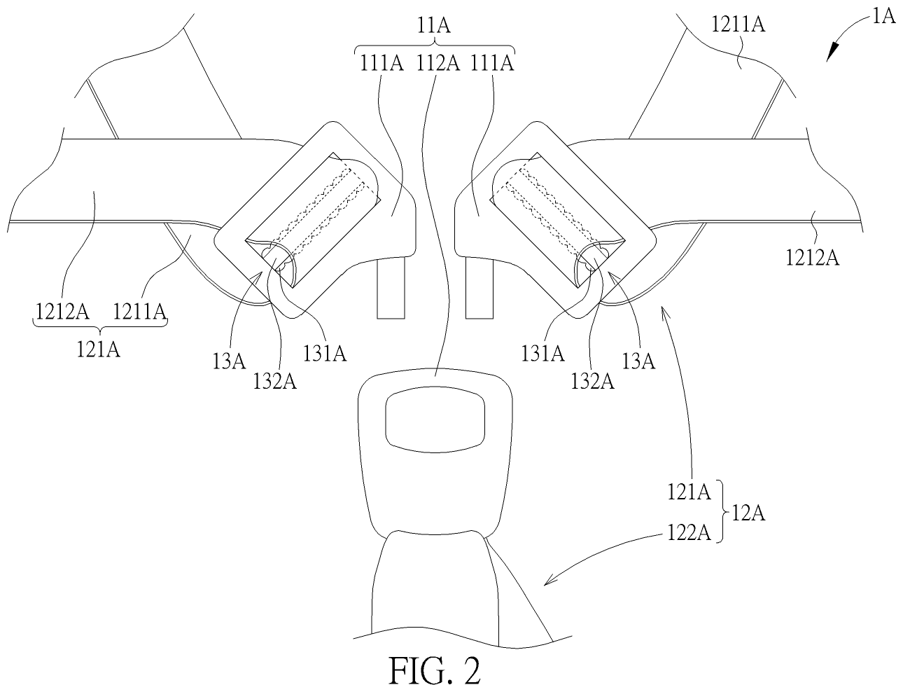

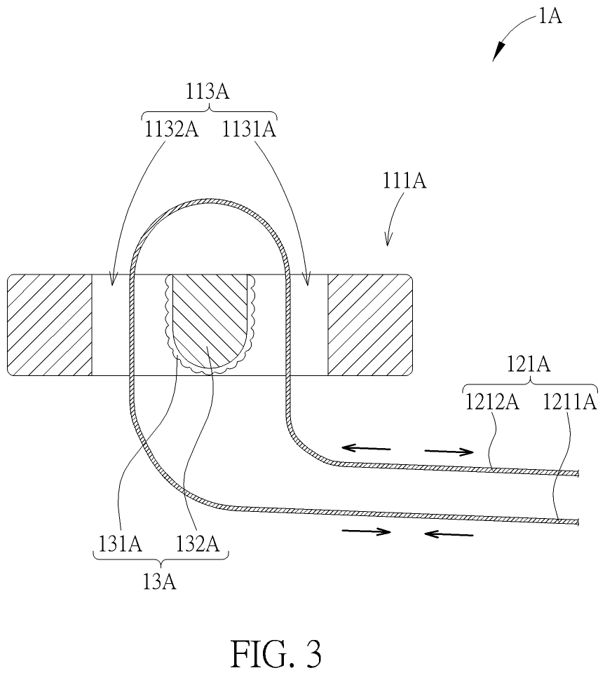

Please refer to FIG. 2 and FIG. 3. FIG. 2 is a partial diagram of a harness system 1A according to an embodiment of the present application. FIG. 3 is a partial sectional diagram of the harness system 1A according to the embodiment of FIG. 2 of the present application. As shown in FIG. 2 and FIG. 3, the harness system 1A includes a buckle assembly 11A, a strap assembly 12A and two restraining devices 13A. The buckle assembly 11A includes two upper buckles 111A and a crotch buckle 112A. The strap assembly 12A includes two upper straps 121A and a crotch strap 122A. Each upper strap 121A is connected to the corresponding upper buckle 111A by slidably passing through the corresponding upper buckle 111A. The crotch strap 122A is connected to the crotch buckle 112A by slidably passing through the crotch buckle 112A. Each upper strap 121A includes a shoulder portion 1211A and a waist portion 1212A divided by the corresponding upper buckle 111A. The shoulder portions 1211A and the waist portions 1212A of the two upper straps 121A and the crotch strap 122A can secure a passenger sitting in a seat of a vehicle cooperatively when the two upper buckles 111A are buckled with the crotch buckle 112A. Each restraining device 13A is configured to restrain a sliding movement of the corresponding upper buckle 111A relative to the corresponding upper strap 121A and toward the waist portion 1212A of the corresponding upper strap 121A when the shoulder portion 1211A of the corresponding upper strap 121A is forced by a passenger's chest or shoulder during a collision or an emergency brake of the vehicle, to prevent an excessive decrease of a length of the waist portion 1212A of the corresponding upper strap 121A and prevent a potential risk of injury of the passenger's waist or abdomen.

In this embodiment, a through slot 113A is formed on each upper buckle 111A. Each restraining device 13A includes an anti-sliding structure 131A and a beam structure 132A. Each beam structure 132A is fixedly disposed on the corresponding upper buckle 111A. Each through slot 113A includes a first portion 1131A and a second portion 1132A divided by the corresponding beam structure 132A. The first portion 1131A of each through slot 113A is adjacent to the waist portion 1212A of the corresponding upper strap 121A. The second portion 1132A of each through slot 113A is adjacent to the shoulder portion 1211A of the corresponding upper strap 121A. Each upper strap 121A passes through the first portion 1131A of the corresponding through slot 113A from bottom to top and passes through the second portion 1132A of the corresponding through slot 113A from top to bottom. Each anti-sliding structure 131A is disposed on a wall of the corresponding beam structure 132A and configured to engage with the corresponding upper strap 121A.

Specifically, the anti-sliding structure 131A can include a plurality of engaging teeth disposed on the wall of the beam structure 132A and located within the first portion 1131A and the second portion 1132A of the through slot 113A, so as to provide higher coefficient of friction between the upper strap 121A and the upper buckle 111A to prevent the upper buckle 111A from sliding relative to the upper strap 121A and toward the waist portion 1212A of the upper strap 121A. However, the present application is not limited to this embodiment. For example, in another embodiment, the anti-sliding structure can include a plurality of engaging teeth located within one of the first portion and the second portion of the through slot. Alternatively, in another embodiment, the anti-sliding structure can include any other structure which provides a rough surface contacting with the crotch strap for increasing coefficient of the friction between the crotch strap and the crotch buckle.

When the shoulder portion 1211A is forced by forward movement of the passenger's chest or shoulder during an emergency brake or a vehicle collision, the upper strap 121A is forced to attach with the anti-sliding structure 131A, so that the anti-sliding structure 131A can engage with the upper strap 121A for restraining the sliding movement of the upper buckle 111A relative to the upper strap 121A and toward the waist portion 1212A, so as to prevent the excessive decrease of the length of the waist portion 1212A of the upper strap 121A and prevent the potential risk of the injury of the passenger's waist or abdomen.

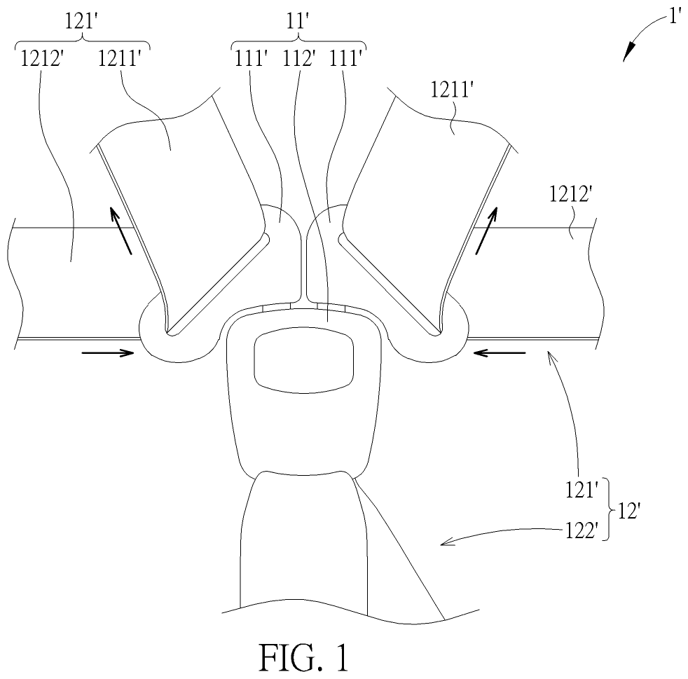

However, in the related art, as shown in FIG. 1, when an emergency brake or a collision of a vehicle occurs, the shoulder portion 1211′ of the upper strap component 121′ is usually forced by forward movement of the passenger's upper body, such as the passenger's chest or shoulder, to drive the upper buckle component 111′ to slide relative to the upper strap component 121′ and toward the waist portion 1212′ to reduce a length of the waist portion 1212′ in a situation before forward movement of the passenger's lower body, such as the passenger's waist or abdomen. The reduced length of the waist portion 1212′ restrains the forward movement of the passenger's lower body and increases an acceleration force acting on the passenger's lower body. Therefore, it may cause injury of the passenger's lower body.

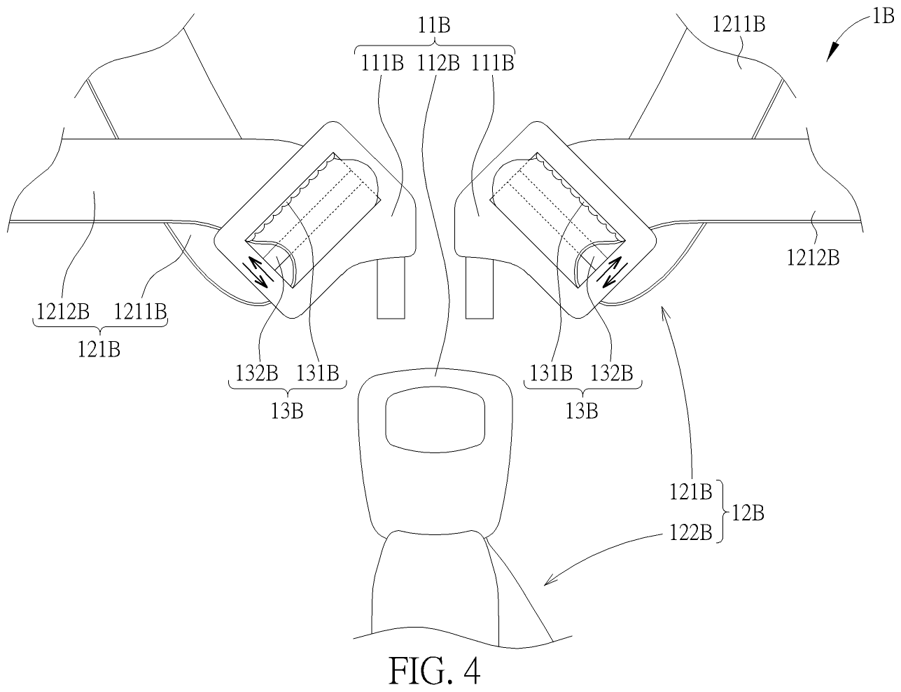

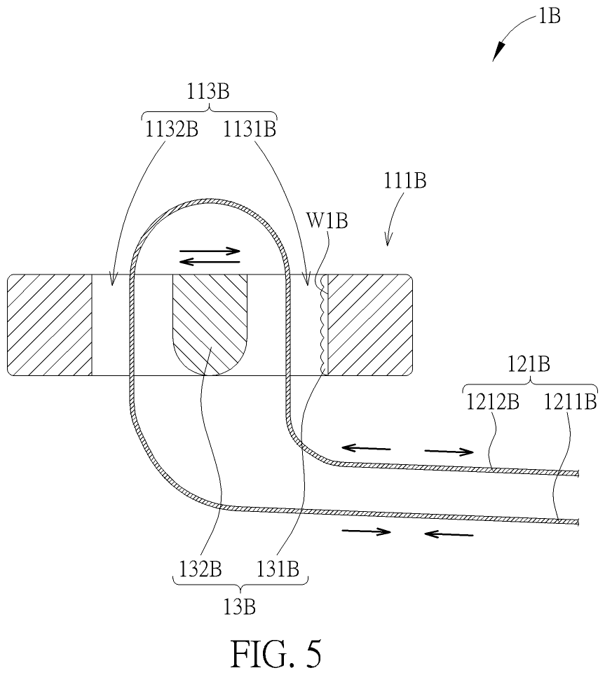

Please refer to FIG. 4 and FIG. 5. FIG. 4 is a partial diagram of a harness system 1B according to another embodiment of the present application. FIG. 5 is a partial sectional diagram of the harness system 1B according to the embodiment of FIG. 4 of the present application. As shown in FIG. 4 and FIG. 5, the harness system 1B includes a buckle assembly 11B, a strap assembly 12B and two restraining devices 13B. The buckle assembly 11B includes two upper buckles 111B and a crotch buckle 112B. The strap assembly 12B includes two upper straps 121B and a crotch strap 122B. Each upper strap 121B is connected to the corresponding upper buckle 111B by slidably passing through the corresponding upper buckle 111B. The crotch strap 122B is connected to the crotch buckle 112B by slidably passing through the crotch buckle 112B. Each upper strap 121B includes a shoulder portion 1211B and a waist portion 1212B divided by the corresponding upper buckle 111B.

Each restraining device 13B includes an anti-sliding structure 131B and a beam structure 132B. Each beam structure 132B is slidably disposed on the corresponding upper buckle 111B. A through slot 113B is formed on each upper buckle 111B and includes a first portion 1131B and a second portion 1132B divided by the corresponding beam structure 132B. Each first portion 1131B is adjacent to the corresponding waist portion 1212B. Each second portion 1132B is adjacent to the corresponding shoulder portion 1211B. Each upper strap 121B passes through the corresponding first portion 1131B from bottom to top and passes through the corresponding second portion 1132B from top to bottom. Each anti-sliding structure 131B is disposed on a wall W1B of the first portion 1131B of the corresponding through slot 113B facing toward the corresponding beam structure 132B and configured to engage with the corresponding upper strap 121B.

However, the present application is not limited to this embodiment. For example, in another embodiment, the anti-sliding structure can be disposed on a wall of the beam structure facing toward the wall of the first portion of the through slot or disposed on both of the wall of the beam structure and the wall of the first portion of the through slot facing toward each other.

When the shoulder portion 1211B is forced by forward movement of the passenger's chest or shoulder during an emergency brake or a vehicle collision, the upper strap 121B is forced to drive the beam structure 132B to slide relative to the upper buckle 111B and toward the wall W1B of the first portion 1131B of the through slot 113B, so that the upper strap 121B is clamped between the beam structure 132B and the wall W1B of the first portion 1131B and is attached with the anti-sliding structure 131B. Therefore, the upper strap 121B can be engaged by the anti-sliding structure 131B for restraining a sliding movement of the upper buckle 111B relative to the upper strap 121B and toward the waist portion 1212B, so as to prevent an excessive decrease of a length of the waist portion 1212B of the corresponding upper strap 121B and prevent the potential risk of the injury of the passenger's waist or abdomen.

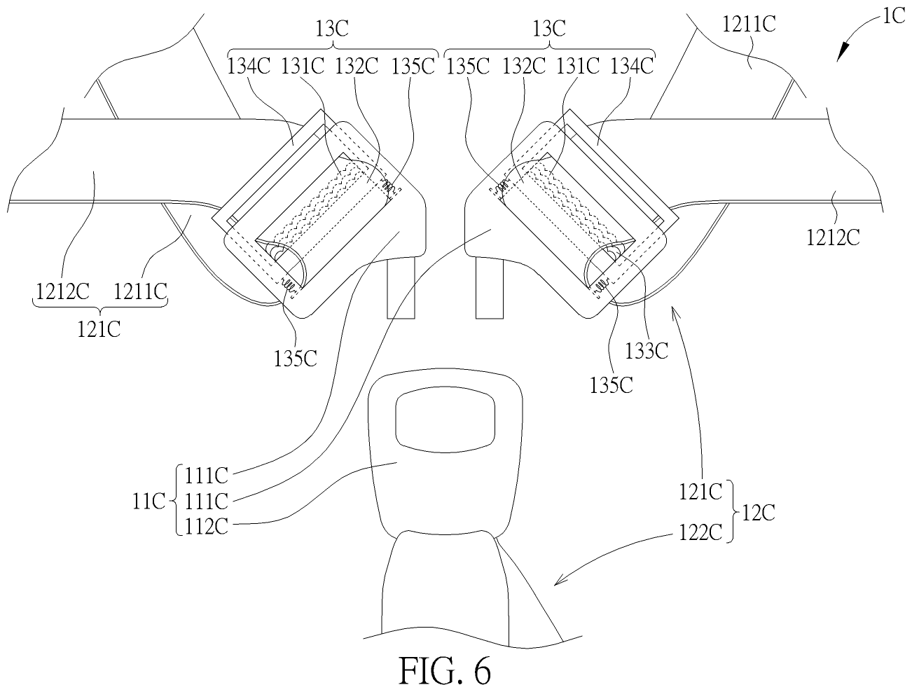

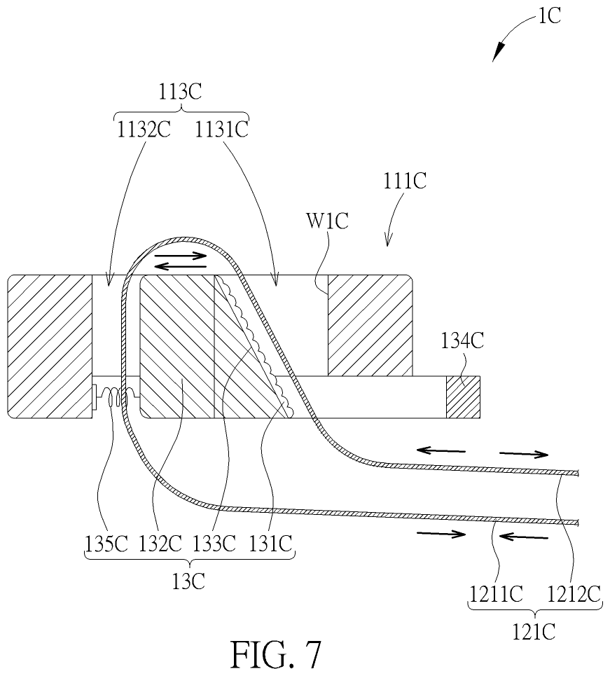

Please refer to FIG. 6 and FIG. 7. FIG. 6 is a partial diagram of a harness system 1C according to another embodiment of the present application. FIG. 7 is a partial sectional diagram of the harness system 1C according to the embodiment of FIG. 6 of the present application. As shown in FIG. 6 and FIG. 7, the harness system 1C includes a buckle assembly 11C, a strap assembly 12C and two restraining devices 13C. The buckle assembly 11C includes two upper buckles 111C and a crotch buckle 112C. The strap assembly 12C includes two upper straps 121C and a crotch strap 122C. Each upper strap 121C is connected to the corresponding upper buckle 111C by slidably passing through the corresponding upper buckle 111C. The crotch strap 122C is connected to the crotch buckle 112C by slidably passing through the crotch buckle 112C. Each upper strap 121C includes a shoulder portion 1211C and a waist portion 1212C divided by the corresponding upper buckle 111C.

Each restraining device 13C includes an anti-sliding structure 131C, a beam structure 132C, a slanted surface structure 133C, an operating structure 134C and two recovering components 135C. Each beam structure 132C is slidably disposed on the corresponding upper buckle 111C. Each operating structure 134C is connected to the corresponding beam structure 132C to form a rectangular component. A through slot 113C is formed on each upper buckle 111C and includes a first portion 1131C and a second portion 1132C divided by the corresponding beam structure 132C. Each first portion 1131C is adjacent to the corresponding waist portion 1212C. Each second portion 1132C is adjacent to the corresponding shoulder portion 1211C. Each upper strap 121C passes through the corresponding first portion 1131C from bottom to top and passes through the corresponding second portion 1132C from top to bottom. Each operating structure 134C is configured to drive the corresponding beam structure 132C to slide away from a wall W1C of the corresponding first portion 1131C. Each slanted surface structure 133C is disposed on a wall of the corresponding beam structure 132C adjacent to the corresponding first portion 1131C. A protruding length of each slanted surface structure 133C increases from top to bottom, so as to form a wedge-shaped structure or a trapezoid-shaped structure together with the beam structure 132C. Each anti-sliding structure 131C is disposed on the corresponding slanted surface structure 133C and configured to engage with the upper strap 121C. Each recovering component 135C is abutted between the corresponding beam structure 132C and the corresponding upper buckle 111C to drive the corresponding beam structure 132C to slide toward the wall W1C of the corresponding first portion 1131C of the corresponding through slot 113C.

In this embodiment, due to the configuration of the recovering component 135C, the upper strap 121C is clamped between the beam structure 132C and the wall W1C of the first portion 1131C unless the beam structure 132C is driven to slide away from the wall W1C of the first portion 1131C by operating the operating structure 134C. Therefore, the upper strap 121C is attached with the anti-sliding structure 131C for restraining a sliding movement of the upper buckle 111C relative to the upper strap 121C and toward the waist portion 1212C when the shoulder portion 1211C is forced to drive the upper buckle 111C to slide relative to the upper strap 121C and toward the waist portion 1212C. However, the upper strap 121C is not attached with the anti-sliding structure 131C due to the configuration of the slanted surface structure 133C when the waist portion 1212C is forced to drive the upper buckle 111C to slide relative to the upper strap 121C toward the shoulder portion 1211C, which facilitates the upper buckle 111C to slide relative to the upper strap 121C and toward the shoulder portion 1211C.

In detailed, when the shoulder portion 1211C is forced by forward movement of the passenger's chest or shoulder during an emergency brake or a vehicle collision, the upper strap 121C is forced to attach with the anti-sliding structure 131C because the upper strap 121C is clamped between the wall W1C of the first portion 1131C and the beam structure 132C driven by the recovering component 135C. Therefore, the upper strap 121C can be engaged by the anti-sliding structure 131C for restraining the sliding movement of the upper buckle 111C relative to the upper strap 121C and toward the waist portion 1212C, so as to prevent an excessive decrease of a length of the waist portion 1212C of the corresponding upper strap 121C and prevent the potential risk of the injury of the passenger's waist or abdomen.

Furthermore, when it is desired to slide the upper buckle 111C relative to the upper strap 121C and toward the waist portion 1212C to manually extend a length of the shoulder portion 1211C, it has to operate the operating structure 134C to drive the beam structure 132C to slide away from the wall W1C of the first portion 1131C of the through slot 113C, so that the upper strap 121C is not clamped between the beam structure 132C and the wall W1C of the first portion 1131C. At this moment, the upper strap 121C is not attached with the anti-sliding structure 131C when the upper strap 121C is forced, and therefore, the upper buckle 111C is allowed to slide relative to the upper strap 121C and toward the waist portion 1212C to extend the length of the shoulder portion 1211C.

Besides, when it is desired to slide the upper buckle 111C relative to the upper strap 121C and toward the shoulder portion 1211C to manually extend the length of the waist portion 1212C, the upper buckle 111C is allowed to slide relative to the upper strap 121C and toward the shoulder portion 1211C directly without operating the operating structure 134C because the upper strap 121C is not attach with the anti-sliding structure 131C due to the configuration of the slanted surface structure 133C when the waist portion 1212C is forced. In other words, the slanted surface structure 133C can achieve a purpose of allowing the upper buckle 111C to slide relative to the upper strap 121C and toward the shoulder portion 1211C when the operating structure 134C is not operated.

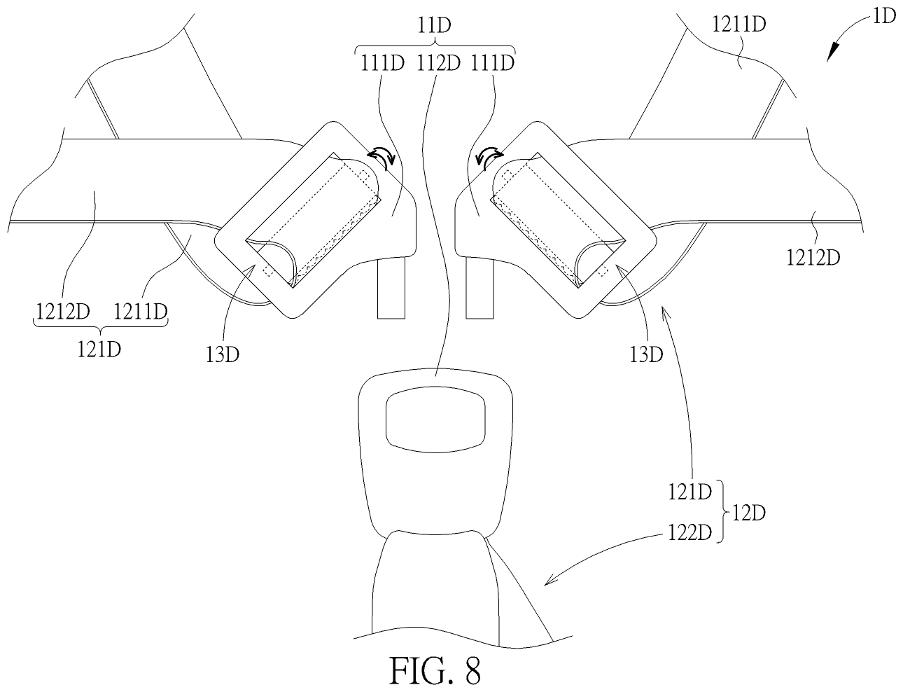

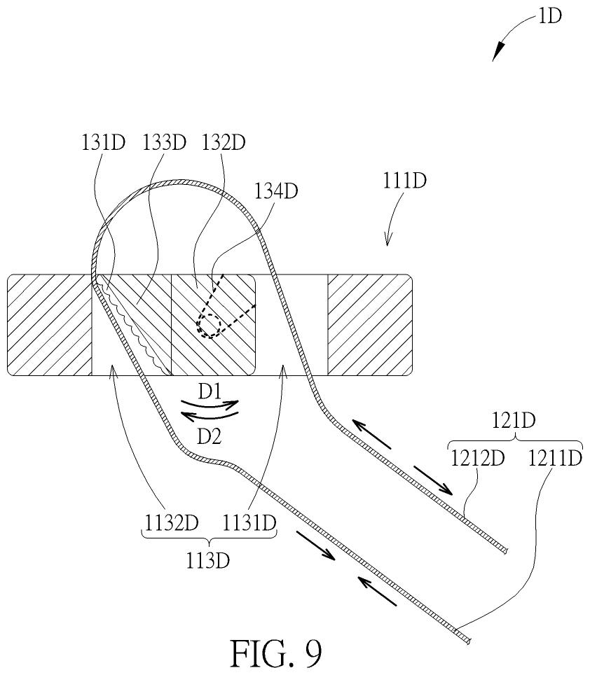

Please refer to FIG. 8 and FIG. 9. FIG. 8 is a partial diagram of a harness system 1D according to another embodiment of the present application. FIG. 9 is a partial sectional diagram of the harness system 1D according to the embodiment of FIG. 8 of the present application. As shown in FIG. 8 and FIG. 9, the harness system 1D includes a buckle assembly 11D, a strap assembly 12D and two restraining devices 13D. The buckle assembly 11D includes two upper buckles 111D and a crotch buckle 112D. The strap assembly 12D includes two upper straps 121D and a crotch strap 122D. Each upper strap 121D is connected to the corresponding upper buckle 111D by slidably passing through the corresponding upper buckle 111D. The crotch strap 122D is connected to the crotch buckle 112D by slidably passing through the corresponding crotch buckle 112D. Each upper strap 121D includes a shoulder portion 1211D and a waist portion 1212D divided by the corresponding upper buckle 111D.

Each restraining device 13D includes an anti-sliding structure 131D, a beam structure 132D, a slanted surface structure 133D and a recovering component 134D. A through slot 113D is formed on each upper buckle 111D. Each beam structure 132D is rotatably disposed on the corresponding upper buckle 111D. Each through slot 113D includes a first portion 1131D and a second portion 1132D divided by the corresponding beam structure 132D. Each first portion 1131D is adjacent to the corresponding waist portion 1212D. Each second portion 1132D is adjacent to the corresponding shoulder portion 1211D. Each upper strap 121D passes through the first portion 1131D of the corresponding through slot 113D from bottom to top and passes through the corresponding second portion 1132D from top to bottom. Each slanted surface structure 133D is disposed on a wall of the corresponding beam structure 132D adjacent to a wall of the corresponding second portion 1132D. A protruding length of each slanted surface structure 133D increases from bottom to top, so as to form a wedge-shaped structure or a trapezoid-shaped structure together with the beam structure 132D. Each anti-sliding structure 131D is disposed on the corresponding slanted surface structure 133D. Each recovering component 134D is abutted between the corresponding beam structure 132D and the corresponding upper buckle 111D and configured to drive the corresponding beam structure 132D to rotate along an engaging direction D1.

In this embodiment, the upper strap 121D is clamped between the beam structure 132D and the wall of the second portion 1132D unless the beam structure 132D is driven to rotate along a disengaging direction D2 opposite to the engaging direction D1. Therefore, the upper strap 121D is attached with the anti-sliding structure 131D for restraining a sliding movement of the upper buckle 111D and relative to the upper strap 121D and toward the waist portion 1212D when the shoulder portion 1211D is forced to drive the upper buckle 111D to slide relative to the upper strap 121D and toward the waist portion 1212D. However, the upper strap 121D is not attached with the anti-sliding structure 131D due to the configuration of the slanted surface structure 133D and rotating movement of the beam structure 132D along the disengaging direction D2 when the waist portion 1212D is forced to drive the upper buckle 111D to slide relative to the upper strap 121D and toward the shoulder portion 1211D, which facilitates the upper buckle 111D to slide relative to the upper strap 121D and toward the shoulder portion 1211D.

In detailed, when the shoulder portion 1211D is forced by forward movement the passenger's chest or shoulder during an emergency brake or a vehicle collision, the upper strap 121D is forced to attach with the anti-sliding structure 131D because the upper strap 121D is clamped between the wall of the second portion 1132D and the beam structure 132D driven by the recovering component 134D. Therefore, the upper strap 121D can be engaged by the anti-sliding structure 131D for restraining the sliding movement of the upper buckle 111D relative to the upper strap 121D and toward the waist portion 1212D, so as to prevent an excessive decrease of a length of the waist portion 1212D of the corresponding upper strap 121D and prevent the potential risk of the injury of the passenger's waist or abdomen.

When the waist portion 1212D is forced to slide the upper buckle 111D relative to the upper strap 121D and toward the shoulder portion 1211D, the beam structure 132D is driven by the upper strap 121D to rotate relative to upper buckle 111D along the disengaging direction D2, so that the upper strap 121D is not clamped between the wall of the second portion 1132D and the beam structure 132D and not attached with the anti-sliding structure 131D due to the configuration of the slanted surface structure 133D. Therefore, the upper buckle 111D is allowed to slide relative to the upper strap 121C and toward the waist portion 1212D.

In an embodiment, each restraining device can further include an angle restraining component for restraining a rotating angle of the beam structure, so as to prevent an excessive rotation of the beam structure. For example, the angle restraining component can prevent the slanted surface structure and the anti-sliding structure from rotating into the first portion. Furthermore, in another embodiment, the beam structure can include a rotating plate and a shaft. The rotating plate is rotatably disposed on the upper buckle by the shaft and made of metal or plastic material. The anti-sliding structure is disposed on the rotating plate.

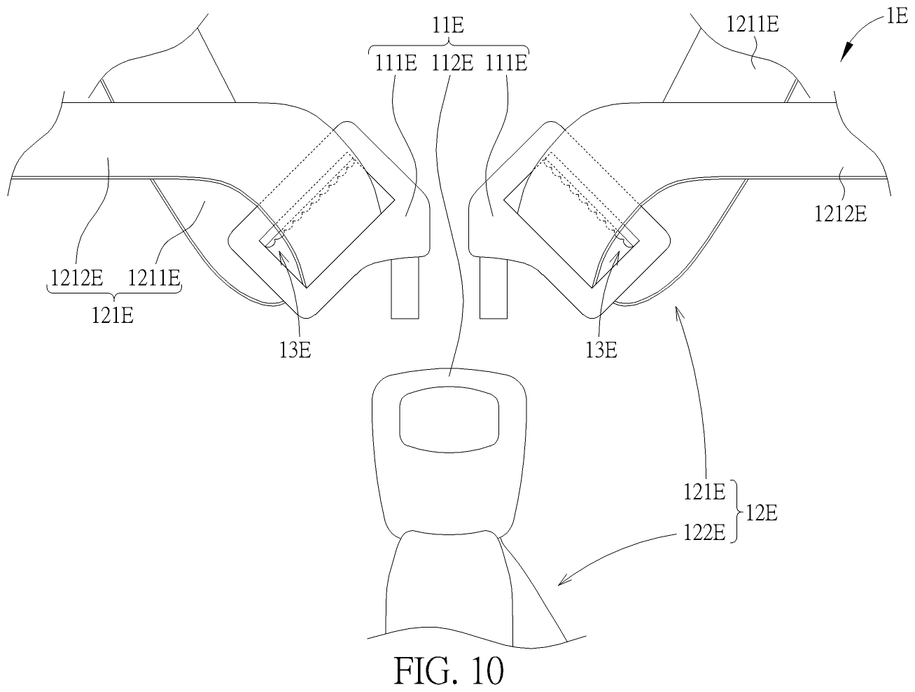

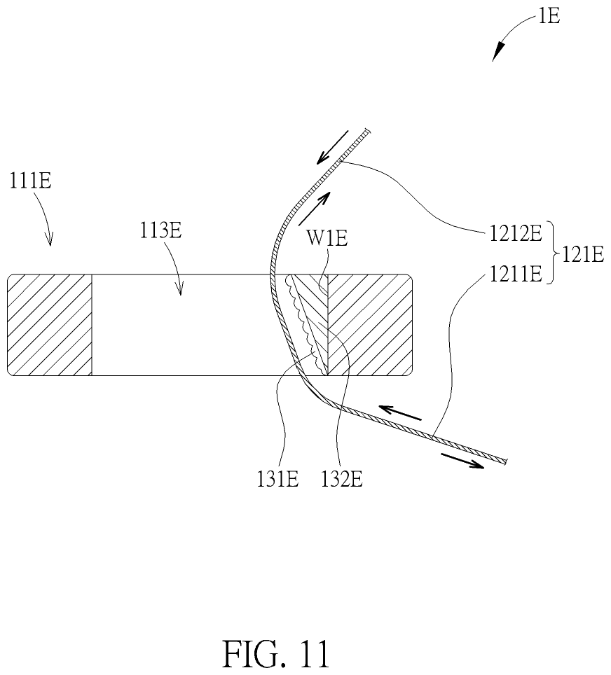

Please refer to FIG. 10 and FIG. 11. FIG. 10 is a partial diagram of a harness system 1E according to another embodiment of the present application. FIG. 11 is a partial sectional diagram of the harness system 1E according to the embodiment of FIG. 10 of the present application. As shown in FIG. 10 and FIG. 11, the harness system 1E includes a buckle assembly 11E, a strap assembly 12E and two restraining devices 13E. The buckle assembly 11E includes two upper buckles 111E and a crotch buckle 112E. The strap assembly 12E includes two upper straps 121E and a crotch strap 122E. Each upper strap 121E is connected to the corresponding upper buckle 111E by slidably passing through the corresponding upper buckle 111E. The crotch strap 122E is connected to the corresponding crotch buckle 112E by slidably passing through the crotch buckle 112E. Each upper strap 121E includes a shoulder portion 1211E and a waist portion 1212E divided by the corresponding upper buckle 111E.

Each restraining device 13E includes an anti-sliding structure 131E and a slanted surface structure 132E. A through slot 113E is formed on each upper buckle 111E. Each upper strap 121E passes through the corresponding through slot 113E. Each slanted surface structure 132E is disposed on a wall W1E of the corresponding through slot 113E. A protruding length of each slanted surface structure 132E increases from bottom to top. Each anti-sliding structure 131E is disposed on the corresponding slanted surface structure 132E. In this embodiment, the upper strap 121E is forced to attach with the anti-sliding structure 131E when the shoulder portion 1211E is forced to drive the upper buckle 111E to slide relative to the upper strap 121E and toward the waist portion 1212E, so that the upper strap 121E can be engaged by the anti-sliding structure 131E for restraining a sliding movement of the upper buckle 111E relative to the upper strap 121E and toward the waist portion 1212E. However, the upper strap 121E is not attached with the anti-sliding structure 131E due to the configuration of the slanted surface structure 132E when the waist portion 1212E is forced to drive the upper buckle 111E to slide relative to the upper strap 121E and toward the shoulder portion 1211E, which facilitates the upper buckle 111D to slide relative to the upper strap 121D and toward the shoulder portion 1211D.

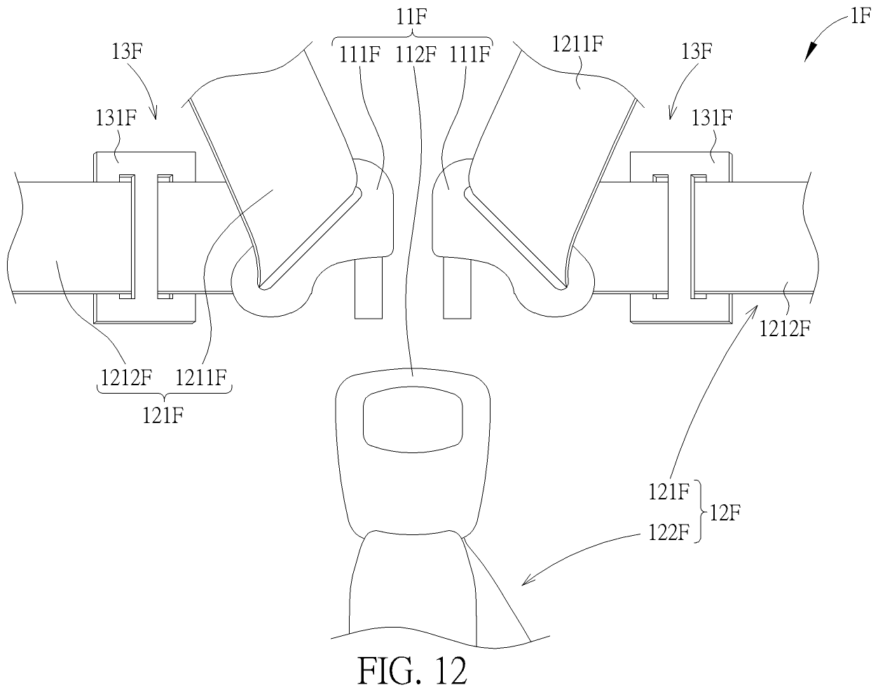

Please refer to FIG. 12. FIG. 12 is a partial diagram of a harness system 1F according to another embodiment of the present application. As shown in FIG. 12, the harness system 1F includes a buckle assembly 11F, a strap assembly 12F and two restraining devices 13F. The buckle assembly 11F includes two upper buckles 111F and a crotch buckle 112F. The strap assembly 12F includes two upper straps 121F and a crotch strap 122F. Each upper strap 121F is connected to the corresponding upper buckle 111F by slidably passing through the corresponding upper buckle 111F. The crotch strap 122F is connected to the corresponding crotch buckle 112F by slidably passing through the crotch buckle 112F. Each upper strap 121F includes a shoulder portion 1211F and a waist portion 1212F divided by the corresponding upper buckle 111F.

Each restraining device 13F includes a stopping component 131F detachably disposed on the corresponding waist portion 1212F and configured to abut against the upper buckle 111F for restraining a sliding movement of the upper buckle 111F relative to the upper strap 121F and toward the waist portion 1212F.

In this embodiment, static friction between the stopping component 131F and the waist portion 1212F can prevent the stopping component 131F from moving relative to the waist portion 1212F after the stopping component 131F is disposed on the waist portion 1212F. The stopping component 131F can be spaced apart the upper buckle 111F. The stopping component 131F can include a tri-glide component. However, the present application is not limited to this embodiment. For example, in another embodiment, the stopping component can still slide relative to the waist portion after the stopping component is disposed on the waist portion. Alternatively, in another embodiment, the stopping component can abut against the upper buckle rather than being spaced apart from the upper buckle when the stopping component is disposed on the waist portion. Alternatively, in another embodiment, the stopping component also can be an E-shaped component, such as an E-shaped plate, or any other component, such as a clipping component, e.g., a paper clip or a hair clip, a buckling component, a Velcro component, and etc. Furthermore, the stopping component can be made of metal or plastic material.

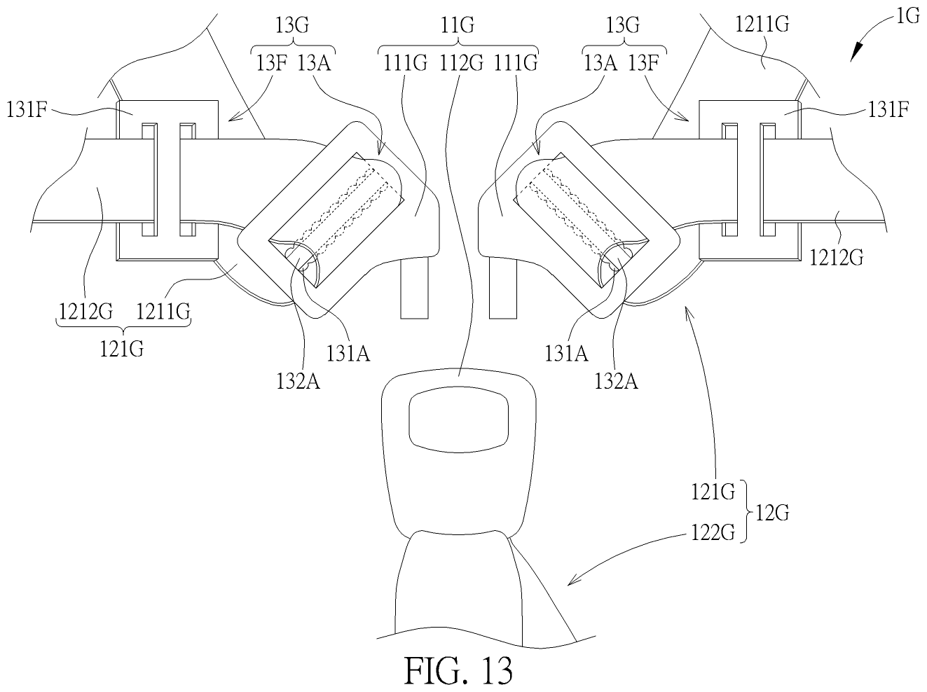

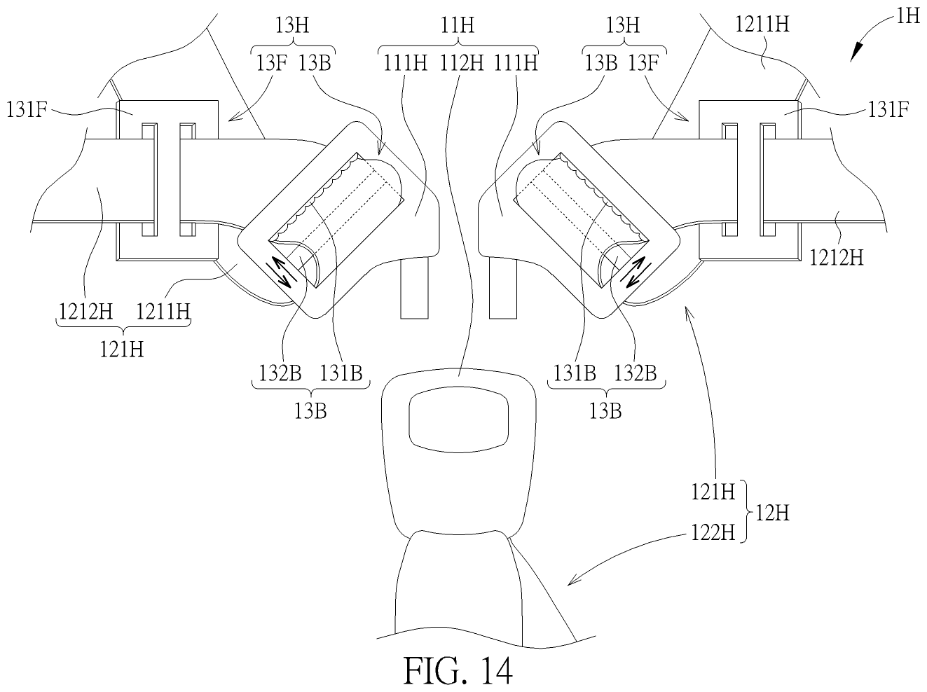

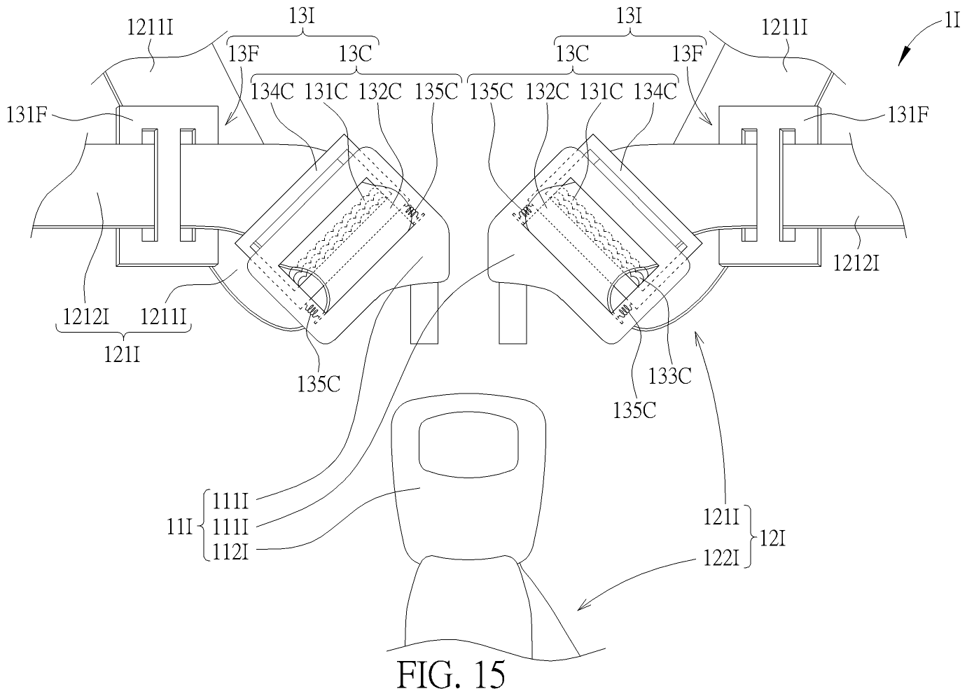

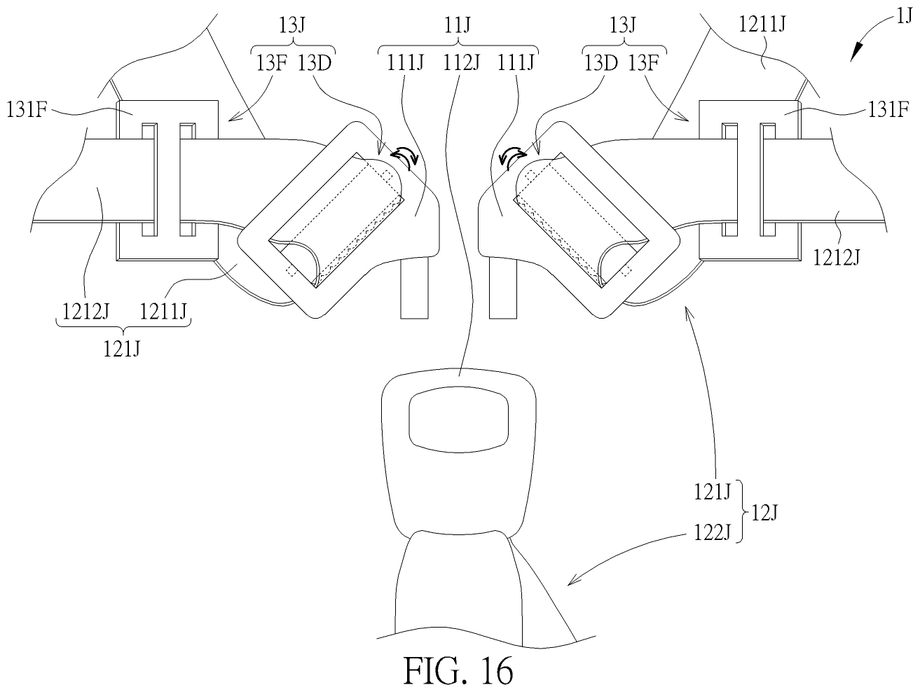

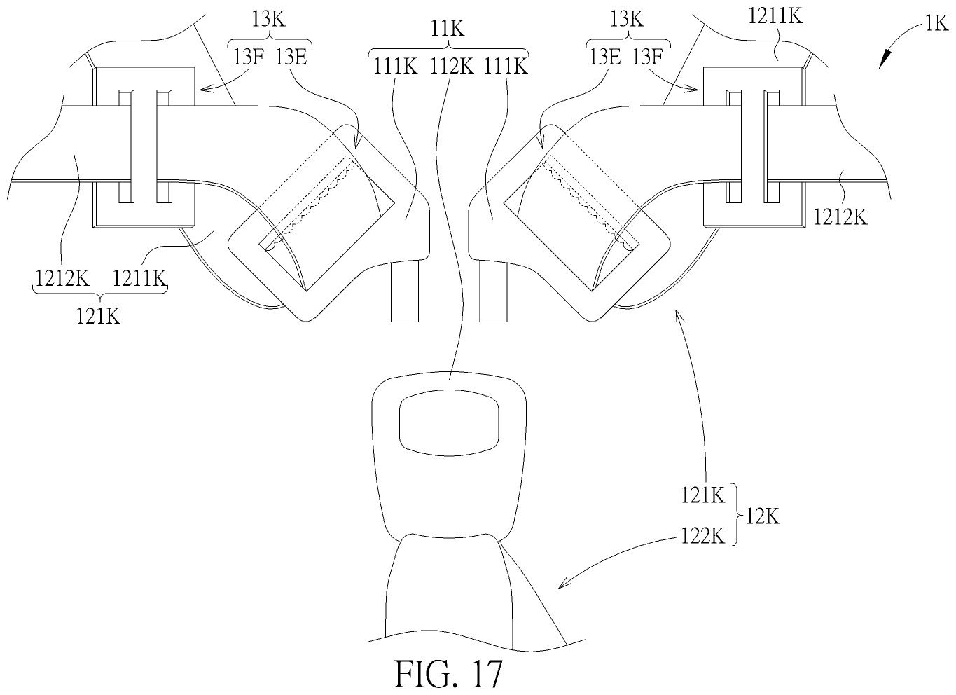

Besides, the harness system of one of the aforementioned embodiments also can further include the stopping component detachably disposed on the waist portion of the upper strap. Please refer to FIG. 13 to FIG. 17. FIG. 13 to FIG. 17 are partial diagrams of a harness system according to other embodiments of the present application. As shown in FIG. 13 to FIG. 17, the sliding movement of the upper buckle relative to the upper strap and toward the shoulder portion can be restrained by the stopping component and the anti-sliding structure cooperatively. As shown in FIG. 13, a harness system 1G includes a restraining device 13G which incorporates the restraining device 13A of the embodiment of FIGS. 2 and 3 and the restraining device 13F of the embodiment of FIG. 11 and FIG. 12. As shown in FIG. 14, a harness system 1H includes a restraining device 13H which incorporates the restraining device 13B of the embodiment of FIG. 4 and FIG. 5 and the restraining device 13F of the embodiment of FIG. 11 and FIG. 12. As shown in FIG. 15, a harness system 1I includes a restraining device 13I which incorporates the restraining device 13C of the embodiment of FIG. 6 and FIG. 7 and the restraining device 13F of the embodiment of FIG. 11 and FIG. 12. As shown in FIG. 16, a harness system 1J includes a restraining device 13J which incorporates the restraining device 13D of the embodiment of FIG. 8 and FIG. 9 and the restraining device 13F of the embodiment of FIG. 11 and FIG. 12. As shown in FIG. 17, a harness system 1K includes a restraining device 13K which incorporates the restraining device 13E of the embodiment of FIGS. 10 and 11 and the restraining device 13F of the embodiment of FIG. 11 and FIG. 12. Detailed description for the stopping component and the anti-sliding structure is omitted herein for simplicity.

In contrast to the related art, the present application utilizes the anti-sliding structure having a higher coefficient of friction to engage with the upper strap. Therefore, the present application can effectively restrain the sliding movement of the upper buckle relative to the upper strap and toward the waist portion by engagement of the anti-sliding structure and the upper strap when the shoulder portion of the upper strap is forced by a passenger's chest or shoulder during an emergency brake or a collision of a vehicle, which prevents an excessive decrease of a length of the waist portion of the upper strap and prevents a potential risk of injury of the passenger's waist or abdomen. Besides, the present application further utilizes the stopping component detachably disposed on the waist portion to abut against the upper buckle. Therefore, the present application can effectively restrain the sliding movement of the upper buckle relative to the upper strap and toward the waist portion by abutment of the stopping component and the upper buckle during the sliding movement of the upper buckle relative to the upper strap and toward the waist portion, which also prevents the excessive decrease of the length of the waist portion of the upper strap and prevents the potential risk of injury of the passenger's waist or abdomen.

Those skilled in the art will readily observe that numerous modifications and alterations of the device and method may be made while retaining the teachings of the invention. Accordingly, the above disclosure should be construed as limited only by the metes and bounds of the appended claims

What is claimed is:

1. A harness system with a buckle restraining function, the harness system comprising:
an upper buckle;
an upper strap slidably passing through the upper buckle and comprising a waist portion and a shoulder portion divided by the upper buckle; and
a restraining device configured to restrain a sliding movement of the upper buckle relative to the upper strap and toward the waist portion when the shoulder portion is forced during a collision or an emergency brake of a vehicle.

2. The harness system of claim 1, wherein a through slot is formed on the upper buckle, the restraining device comprises an anti-sliding structure and a beam structure, the beam structure is disposed on the upper buckle, the through slot comprises a first portion and a second portion divided by the beam structure, the first portion is adjacent to the waist portion, the second portion is adjacent to the shoulder portion, and the upper strap passes through the first portion of the through slot from bottom to top and passes through the second portion of the through slot from top to bottom.

3. The harness system of claim 2, wherein the restraining device further comprises a stopping component detachably disposed on the waist portion and configured to abut against the upper buckle for restraining the sliding movement of the upper buckle relative to the upper strap and toward the waist portion.

4. The harness system of claim 2, wherein the beam structure is fixedly disposed on the upper buckle, the anti-sliding structure is disposed on a wall of the beam structure and configured to engage with the upper strap, and the upper strap is engaged by the anti-sliding structure for restraining the sliding movement of the upper buckle relative to the upper strap and toward the waist portion when the upper strap is forced to attach with the anti-sliding structure.

5. The harness system of claim 4, wherein the restraining device further comprises a stopping component detachably disposed on the waist portion and configured to abut against the upper buckle for restraining the sliding movement of the upper buckle relative to the upper strap and toward the waist portion.

6. The harness system of claim 2, wherein the beam structure is slidably disposed on the upper buckle, the anti-sliding structure is disposed on at least one of a wall of the beam structure and a wall of the first portion of the through slot facing toward each other and configured to engage with the upper strap, and the upper strap is engaged by the anti-sliding structure for restraining the sliding movement of the upper buckle relative to the upper strap and toward the waist portion when the upper strap is forced to drive the beam structure to slide relative to the upper buckle and toward the wall of the first portion of the through slot.

7. The harness system of claim 6, wherein the restraining device further comprises a stopping component detachably disposed on the waist portion and configured to abut against the upper buckle for restraining the sliding movement of the upper buckle relative to the upper strap and toward the waist portion.

8. The harness system of claim 2, wherein the beam structure is slidably disposed on the upper buckle, the restraining device further comprises a slanted surface structure disposed on a wall of the beam structure adjacent to the first portion of the through slot, a protruding length of the slanted surface structure increases from top to bottom, the anti-sliding structure is disposed on the slanted surface structure, and the upper strap is engaged by the anti-sliding structure for restraining the sliding movement of the upper buckle relative to the upper strap and toward the waist portion when the upper strap is forced to attach with the anti-sliding structure.

9. The harness system of claim 8, wherein the restraining device further comprises a stopping component detachably disposed on the waist portion and configured to abut against the upper buckle for restraining the sliding movement of the upper buckle relative to the upper strap and toward the waist portion.

10. The harness system of claim 8, wherein the restraining device further comprises an operating structure and a recovering component, the operating structure is connected to the beam structure, the recovering component is abutted between the beam structure and the upper buckle, the operating structure is configured to drive the beam structure to slide away from a wall of the first portion of the through slot, and the recovering component is configured to drive the beam structure to slide toward the wall of the first portion of the through slot.

11. The harness system of claim 10, wherein the restraining device further comprises a stopping component detachably disposed on the waist portion and configured to abut against the upper buckle for restraining the sliding movement of the upper buckle relative to the upper strap and toward the waist portion.

12. The harness system of claim 2, wherein the beam structure is rotatably disposed on the upper buckle, the anti-sliding structure is disposed on at least one of a wall of the beam structure and a wall of the second portion of the through slot, the anti-sliding structure is configured to engage with the upper strap, and the upper strap is engaged by the anti-sliding structure for restraining the sliding movement of the upper buckle relative to the upper strap and toward the waist portion when the upper strap is forced to drive the beam structure to rotate relative to the upper buckle along an engaging direction.

13. The harness system of claim 12, wherein the restraining device further comprises a stopping component detachably disposed on the waist portion and configured to abut against the upper buckle for restraining the sliding movement of the upper buckle relative to the upper strap and toward the waist portion.

14. The harness system of claim 12, wherein the restraining device further comprises a slanted surface structure disposed on the wall of the beam structure, a protruding length of the slanted surface structure increases from bottom to top, and the anti-sliding structure is disposed on the slanted surface structure.

15. The harness system of claim 14, wherein the restraining device further comprises a stopping component detachably disposed on the waist portion and configured to abut against the upper buckle for restraining the sliding movement of the upper buckle relative to the upper strap and toward the waist portion.

16. The harness system of claim 12, wherein the restraining device further comprises a recovering component abutted between the beam structure and the upper buckle and configured to drive the beam structure to rotate along the engaging direction.

17. The harness system of claim 16, wherein the restraining device further comprises a stopping component detachably disposed on the waist portion and configured to abut against the upper buckle for restraining the sliding movement of the upper buckle relative to the upper strap and toward the waist portion.

18. The harness system of claim 1, wherein a through slot is formed on the upper buckle, the upper strap slidably passes through the through slot, the restraining device comprises a slanted surface structure and an anti-sliding structure, the slanted surface structure is disposed on a wall of the through slot, a protruding length of the slanted surface structure increases from bottom to top, the anti-sliding structure is disposed on the slanted surface structure, and the upper strap is engaged by the anti-sliding structure for restraining the sliding movement of the upper buckle relative to the upper strap and toward the waist portion when the upper strap is forced to attach with the anti-sliding structure.

19. The harness system of claim 18, wherein the restraining device further comprises a stopping component detachably disposed on the waist portion and configured to abut against the upper buckle for restraining the sliding movement of the upper buckle relative to the upper strap and toward the waist portion.

20. The harness system of claim 1, wherein the restraining device comprises a stopping component detachably disposed on the waist portion and configured to abut against the upper buckle for restraining the sliding movement of the upper buckle relative to the upper strap and toward the waist portion.
